(19) United States
(12) Patent Application Publication
(10) Pub. No.: US 2017/0081108 A1
(43) Pub. Date: Mar. 23, 2017

(54) CONTAINER PROVIDING THERMAL INSULATION AND HAVING THREE-DIMENSIONAL COLORED GLITTER PATTERN

(71) Applicant: KUN-CHE Li, Tainan (TW)

(72) Inventors: KUN-CHE LI, TAINAN (TW); KUN-MU LI, TAINAN (TW)

(21) Appl. No.: 14/857,987

(22) Filed: Sep. 18, 2015

(51) Int. Cl. B65D 81/38; B32B 27/20; B32B 5/18; B32B 1/02; B32B 27/08

(52) U.S. Cl. CPC B65D 81/3823; B32B 1/02; B32B 27/08; B32B 5/18; B32B 27/20; B32B 2439/02; B32B 2307/304; B32B 2264/102; B32B 2307/416

(57) ABSTRACT

A container providing thermal insulation and having three dimensional colored glitter patterns is revealed. The container includes an inner body layer and an outer pattern layer having three-dimensional colored glitter patterns. The inner body layer is formed by injected plastic mixed with microspheres for providing thermal insulation and better heat/cold retention properties. The outer pattern layer consists of a foam substrate layer, a substrate layer, a reflection layer, a printed layer and uneven patterns. The foam substrate layer, the substrate layer, the reflection layer, and the printed layer are stacked in turn while the uneven patterns are formed by hot pressing after the foam substrate layer, the substrate layer, and the reflection layer being integrated into one part. Or the uneven patterns are formed by hot pressing after the foam substrate layer, the substrate layer, the reflection layer, and the printed layer being integrated into one part.

### BACKGROUND OF THE INVENTION

Field of the Invention

The present invention relates to a container, especially to a container providing thermal insulation for better heat/cold retention and having three-dimensional colored glitter patterns.

Descriptions of Related Art

Expandable polystyrene is made from a petroleum by-product-polystyrene (PS) being added with a blowing agent and heated. EPS foam is more than 95% air and only about 5% plastic. Polystyrene foams are used in various forms of packaging materials such as disposable tableware, beverage container, cushioning material for appliances, because of a set of good properties including low water absorption, good damping, good thermal insulation, and light weight.

However, EPS foam doesn't degrade over time. Thus EPS foam is not suitable to be sitting in a landfill. Moreover, toxic materials such as styrene monomer are generated after EPS being heated. Long term exposure to these toxic materials shows increased cancer risk. Once acidic or hot drink is poured into a container made from EPS, toxic substances are released into the drink. This also increases the risk of cancers. Thus most of the countries in the European Union have banned the user of polystyrene foam.

Furthermore, a composite container is available on the market. The composite material is made from a paper container coated with a thermal-insulated foam layer on an inner wall thereof. However, the composite container still has the shortcomings mentioned above such as the release of toxic substances while in contact with acidic or hot fluid.

This also causes serious health problems. In addition, the connection between the foam layer and the inner wall of the container results in problems in recycling.

### SUMMARY OF THE INVENTION

Therefore it is a primary object of the present invention to provide a container that not only provides heat insulation to keep contents in the container warm/cold.

It is another object of the present invention to provide a container with three-dimensional colored glitter patterns.

In order to achieve the above objects, a container that provides thermal insulation for better heat/cold retention and has three-dimensional colored glitter patterns according to the present invention includes an inner body layer and an outer pattern layer having three-dimensional colored glitter patterns being connected to the inner body layer.

The inner body layer is formed by a mixture of injected plastic with hollow microspheres. Thus the inner body layer provides thermal insulation and heat/cold retention.

The outer pattern layer with three-dimensional colored glitter patterns is mainly composed of a foam substrate layer, a substrate layer, a reflection layer, a printed layer and uneven patterns. The foam substrate layer, the substrate layer, the reflection layer, and the printed layer are stacked in turn. The uneven patterns are formed by hot pressing after the foam substrate layer, the substrate layer, and the reflection layer being connected to form one part or after the foam substrate layer, the substrate layer, the reflection layer and the printed layer being connected to form one part. Thereby the outer pattern layer with three-dimensional colored glitter patterns is produced.

The injected plastic is selected from the group consisting of polypropylene (PP), acrylonitrile butadiene styrene (ABS), polystyrene (PS), polycarbonate (PC), polymethylmethacrylate (PMMA) and ethylene vinyl acetate (EVA).

The foam material for the foam substrate layer is corresponding to the material for the injected plastic 11, including polypropylene (PP) foam, acrylonitrile butadiene styrene (ABS) foam, polystyrene (PS) foam, polycarbonate (PC) foam, polymethylmethacrylate (PMMA) foam and ethylene vinyl acetate (EVA) foam.

The material for the substrate layer is selected from the group consisting of ethylene-vinyl acetate (EVA) copolymer, polyethylene (PE), a mixture of EVA copolymer with maleic anhydride (MA) and a mixture of PE with MA.

The microspheres are produced by silicon dioxide (SiO₂) and aluminium oxide (Al₂O₃) sintered at a high temperature of 1400 degrees Celsius (° C.) and sorted.

The reflection layer is formed by a polyethylene terephthalate (PET) film with surface treatment of electroplating.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a partial enlarged view of a cross section of an embodiment according to the present invention;

FIG. 2 is schematic drawing showing formation of an embodiment according to the present invention;

FIG. 3 is a perspective view of an embodiment according to the present invention;

FIG. 4 is a partial enlarged view of a cross section of another embodiment according to the present invention.

### DETAILED DESCRIPTION OF THE PREFERRED EMBODIMENT

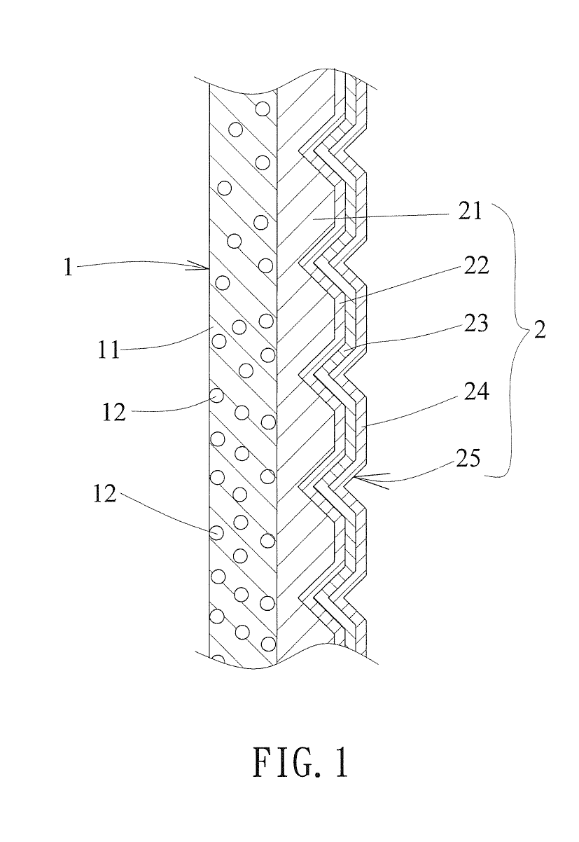

Refer to FIG. 1, a container that provides thermal insulation for better heat/cold retention and has three-dimensional colored glitter patterns according to the present invention includes an inner body layer 1 and an outer pattern layer having three-dimensional colored glitter patterns 2 being connected to the inner body layer 1.

The inner body layer 1 is formed by injected plastic 11 mixed with hollow microspheres 12. Thus the inner body layer 1 provides thermal insulation and better heat/cold retention by the hollow microspheres 12 contained therein.

The outer pattern layer having three-dimensional colored glitter patterns 2 mainly consists of a foam substrate layer 21, a substrate layer 22, a reflection layer 23, a printed layer 24 and uneven patterns 25.

The injected plastic 11 is selected from the group consisting of polypropylene (PP), acrylonitrile butadiene styrene (ABS), polystyrene (PS), polycarbonate (PC), polymethylmethacrylate (PMMA) and Ethylene Vinyl Acetate (EVA).

The microspheres 12 are manufactured from silicon dioxide (SiO₂) and aluminium oxide (Al₂O₃) sintered at a high temperature of 1400 degrees Celsius (° C.) and sorted.

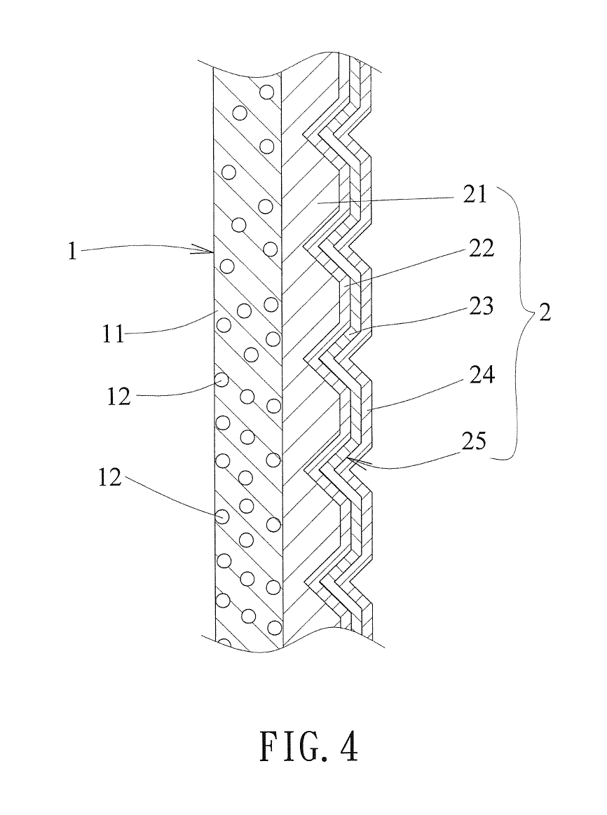

The foam substrate layer 21, the substrate layer 22, the reflection layer 23, and the printed layer 24 are stacked in turn. As to the uneven patterns 25, they can be formed by hot pressing in a mold after the foam substrate layer 21, the substrate layer 22, the reflection layer 23 and the printed layer 24 being connected to form one part, as shown in FIG. 1. The uneven patterns 25 are at the outermost layer of the container. Refer to FIG. 4, the uneven patterns 25 can also be formed by hot pressing in a mold after the foam substrate layer 21, the substrate layer 22, and the reflection layer 23 being connected to form one part. Thereby the outer pattern layer 2 of the container is produced.

The foam substrate layer 21 is made from foam material corresponding to the material for the injected plastic 11, including polypropylene (PP) foam, acrylonitrile butadiene styrene (ABS) foam, polystyrene (PS) foam, polycarbonate (PC) foam, polymethylmethacrylate (PMMA) foam and Ethylene Vinyl Acetate (EVA) foam.

The material for the substrate layer 22 is selected from the group consisting of ethylene-vinyl acetate (EVA) copolymer, polyethylene (PE), a mixture of EVA with Maleic anhydride (MA) and a mixture of PE with MA. A better connection between the foam substrate layer 21 and the reflection layer 23 through the substrate layer 22 is achieved due to the MA added in the substrate layer 22.

Moreover, the reflection layer 23 is formed by a polyethylene terephthalate (PET) film with surface treatment of electroplating. Thus the reflection layer 23 is able to reflect light.

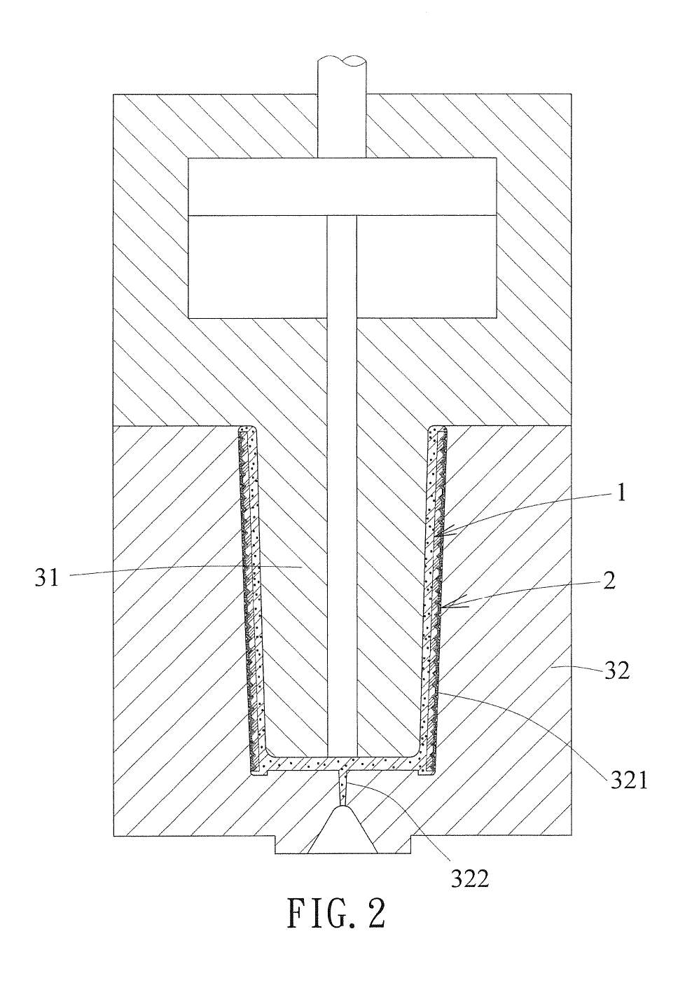

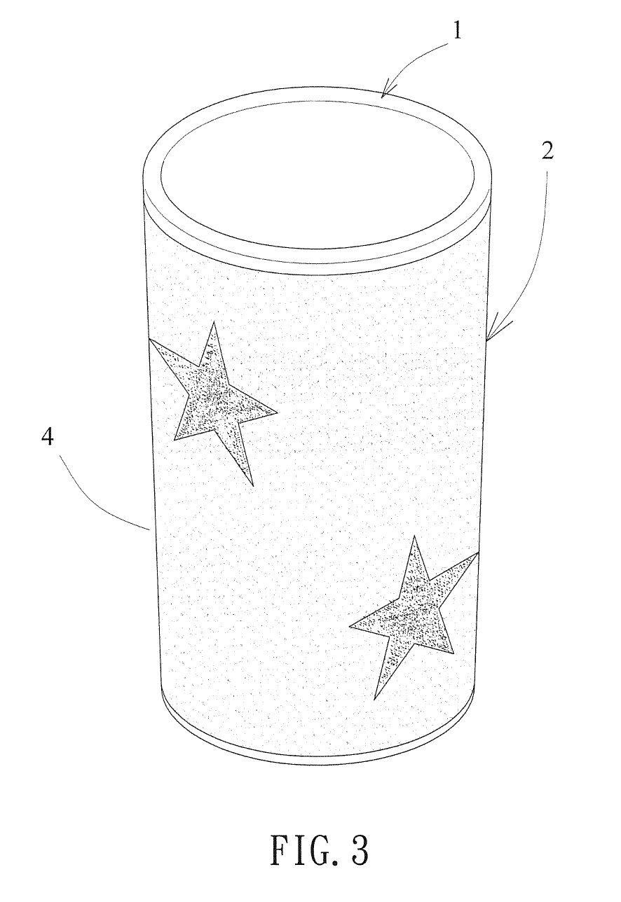

Refer to FIG. 2, a schematic drawing showing formation of the container of the present invention is revealed. First the outer pattern layer having three-dimensional colored glitter patterns 2 is formed. Then the outer pattern layer having three-dimensional colored glitter patterns 2 is set into a mold cavity 321 of a female mold 32 and the female mold 32 and a male mold 31 are connected to each other. Next the injected plastic 11 mixed with the microspheres 12 is filled into the connected mold through a sprue gate 322. After molding, the male mold 31 and the female mold 32 are separated from each other. Thus a container 4 formed by the outer pattern layer with three-dimensional colored glitter patterns 2 disposed over an inner body layer 1 is obtained, as shown in FIG. 3. The container 4 can not only block heat transfer for better heat/cold retention but also has three-dimensional colored glitter patterns.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A container providing thermal insulation and having three dimensional colored glitter patterns comprising:
an inner body layer and an outer pattern layer with three-dimensional colored glitter patterns being connected to the inner body layer;
wherein the inner body layer is formed by injected plastic mixed with hollow microspheres;
wherein outer pattern layer with three-dimensional colored glitter patterns includes a foam substrate layer, a substrate layer, a reflection layer, a printed layer and uneven patterns; the foam substrate layer, the substrate layer, the reflection layer, and the printed layer are stacked in turn.

2. The device as claimed in claim 1, wherein the uneven patterns are formed by hot pressing after the foam substrate layer, the substrate layer, and the reflection layer being connected to form one part.

3. The device as claimed in claim 1, wherein the uneven patterns are formed by hot pressing after the foam substrate layer, the substrate layer, the reflection layer, and the printed layer being connected to form one part.

4. The device as claimed in claim 1, wherein the injected plastic is selected from the group consisting of polypropylene (PP), acrylonitrile butadiene styrene (ABS), polystyrene (PS), polycarbonate (PC), polymethylmethacrylate (PMMA) and ethylene vinyl acetate (EVA).

5. The device as claimed in claim 4, wherein a foam material for the foam substrate layer is corresponding to the injected plastic and is selected from the group consisting of polypropylene (PP) foam, acrylonitrile butadiene styrene (ABS) foam, polystyrene (PS) foam, polycarbonate (PC) foam, polymethylmethacrylate (PMMA) foam and ethylene vinyl acetate (EVA) foam.

6. The device as claimed in claim 5, wherein the substrate layer is made from material selected from the group consisting of ethylene-vinyl acetate (EVA) copolymer, polyethylene (PE), a mixture of EVA copolymer with Maleic anhydride (MA) and a mixture of PE with MA.

7. The device as claimed in claim 6, wherein the microspheres are produced by silicon dioxide (SiO₂) and aluminium oxide (Al₂O₃) sintered at a high temperature of 1400 degrees Celsius (° C.) and sorted.

8. The device as claimed in claim 7, wherein the reflection layer is formed by a polyethylene terephthalate (PET) film with surface treatment of electroplating.

9. The device as claimed in claim 4, wherein the substrate layer is made from material selected from the group consisting of ethylene-vinyl acetate (EVA) copolymer, polyethylene (PE), a mixture of EVA copolymer with Maleic anhydride (MA) and a mixture of PE with MA.

10. The device as claimed in claim 9, wherein the microspheres are produced by silicon dioxide (SiO₂) and aluminium oxide (Al₂O₃) sintered at a high temperature of 1400 degrees Celsius (° C.) and sorted.

11. The device as claimed in claim 10, wherein the reflection layer is formed by a polyethylene terephthalate (PET) film with surface treatment of electroplating.

12. The device as claimed in claim 4, wherein the microspheres are produced by silicon dioxide (SiO₂) and aluminium oxide (Al₂O₃) sintered at a high temperature of 1400 degrees Celsius (° C.) and sorted.

13. The device as claimed in claim 12, wherein the reflection layer is formed by a polyethylene terephthalate (PET) film with surface treatment of electroplating.

14. The device as claimed in claim 4, wherein the reflection layer is formed by a polyethylene terephthalate (PET) film with surface treatment of electroplating.
